(19) United States
(12) Patent Application Publication
(10) Pub. No.: US 2026/0105327 A1
(43) Pub. Date: Apr. 16, 2026

(54) VALIDATING USE OF DATA IN TRAINING OF MACHINE LEARNING MODELS

(71) Applicant: Oracle International Corporation, Redwood Shores, CA (US)

(72) Inventors: Irfan Mekic, Angier, NC (US); Ian Hanus, Belmont, CA (US)

(73) Assignee: Oracle International Corporation, Redwood Shores, CA (US)

(21) Appl. No.: 18/917,353

(22) Filed: Oct. 16, 2024

(51) Int. Cl. G06N 5/04

(52) U.S. Cl. CPC G06N 5/04

(57) ABSTRACT

Techniques for validating use of data in training of machine learning (ML) models are disclosed. Synthetic data is by generated, by sampling from a statistical distribution of user data. The user data and the synthetic data are fed to an inference endpoint of the ML model. First results are generated by the ML model, based on the user data; and second results are generated by the ML model, based on the synthetic data. A statistical analysis is conducted, based at least in part on the first results and the second results. A determination is made as to whether the user data was used for training the ML model, based at least in part on conducting the statistical analysis. An indication of the determination as to whether the user data was used for training the ML model is displayed on a user interface.

### BACKGROUND

In the burgeoning field of artificial intelligence (AI), utilization of machine learning (ML) models has become a cornerstone for developing numerous AI applications. In some AI applications, ML models can recommend items to users. A recommendation system comprises a ML model that provides suggestions or recommendations for items to a particular user, where the recommendation system infers that the recommended items are most likely to be relevant to, or liked by the particular user.

### BRIEF SUMMARY

In some embodiments, a non-transitory computer-readable medium includes instructions that when executed by one or more processors, cause a system including the one or more processors to perform operations including: generating statistical distribution of user data; generating synthetic data by sampling from the statistical distribution of the user data; feeding the user data and the synthetic data to an inference endpoint of a machine learning (ML) model; receiving first results that are generated by the ML model, based on feeding the user data to the inference endpoint of the ML model; receiving second results that are generated by the ML model, based on feeding the synthetic data to the inference endpoint of the ML model; conducting statistical analysis, based at least in part on the first results and the second results; determining whether the user data was used for training the ML model, based at least in part on conducting the statistical analysis; and causing to display an indication of the determination as to whether the user data was used for training the ML model.

In an example, conducting the statistical analysis comprises: generating a user performance metric that is based at least in part on the first results; generating a synthetic performance metric that is based at least in part on the second results; and conducting the statistical analysis, based at least in part on the user performance metric and the synthetic performance metric. In an example, the user data comprises (i) a user input feature that was previously fed to the ML model and (ii) a user output feature that was previously generating by the ML model, based on feeding the user input feature to the ML model, and wherein generating the user performance metric comprises: generating a user recommendation error, based at least in part on a difference between the user output feature and the first results; and generating the user performance metric that is a function of the user recommendation error. In an example, the synthetic data comprises (i) a synthetic input feature and (ii) a synthetic output feature, and wherein generating the user performance metric comprises: generating a synthetic recommendation error, based at least in part on a difference between the synthetic output feature and the second results; and generating the synthetic performance metric that is a function of the synthetic recommendation error. In an example, conducting the statistical analysis comprises comparing the user performance metric with the synthetic performance metric; and determining whether the user data was used for training the ML model comprises: in response to a significant statistical difference between the user performance metric and the synthetic performance metric, determining that the user data was used for training the ML model. In an example, conducting the statistical analysis comprises comparing the user performance metric with the synthetic performance metric; and determining whether the user data was used for training the ML model comprises: in response to a non-significant statistical difference between the user performance metric and the synthetic performance metric, determining that the user data was not used for training the ML model. In an example, conducting the statistical analysis comprises (i) comparing the user performance metric with the synthetic performance metric using a statistical test, wherein the statistical test uses a significance level alpha, and (ii) generating a p-value from the statistical test; and determining whether the user data was used for training the ML model comprises: comparing the significance level alpha with the p-value, to determine whether the user data was used for training the ML model. In an example, determining whether the user data was used for training the ML model comprises: in response to the p-value being lower than the significance level alpha, determining that the user data was used for training the ML model. In an example, determining whether the user data was used for training the ML model comprises: in response to the p-value being higher than the significance level alpha, determining that the user data was not used for training the ML model.

In an example, the ML model is a recommender model that provides recommendation for one or more of videos, audios, or physical or virtual items for shopping. In an example, the user data is first user data, wherein the ML model is a first ML model, and wherein the operations further include: feeding second user data to the inference endpoint of the first ML model; feeding the second user data to a production system that includes a second ML model; receiving (i) third results from the first ML model, and (ii) fourth results from the production system; conducting statistical analysis, based at least in part on the third results and the fourth results; determining whether the first ML model and the second ML model are the same, based at least in part on conducting the statistical analysis; and causing to display an indication of the determination as to whether the first ML model and the second ML model are the same. In an example, conducting the statistical analysis comprises comparing the third results and the fourth results; and determining whether the first ML model and the second ML model are the same comprises: in response to a non-significant statistical difference between the third results and the fourth results, determining that the first ML model and the second ML model are the same. In an example, conducting the statistical analysis comprises comparing the third results and the fourth results; and determining whether the first ML model and the second ML model are the same comprises: in response to a significant statistical difference between the third results and the fourth results, determining that the first ML model and the second ML model are different. In an example, conducting the statistical analysis comprises (i) comparing the third results and the fourth results using a statistical test, wherein the statistical test uses a significance level alpha, and (ii) generating a p-value from the statistical test; and determining whether the user data was used for training the ML model comprises one of: in response to the p-value being lower than the significance level alpha, determining that the first ML model and the second ML model are different; or in response to the p-value being higher than the significance level alpha, determining that the first ML model and the second ML model are the same.

In an example, a computer implemented method comprises: generating statistical distribution of user data; generating synthetic data by sampling from the statistical distribution of the user data; feeding the user data and the synthetic data to an inference endpoint of a machine learning (ML) model; receiving first results that are generated by the ML model, based on feeding the user data to the inference endpoint of the ML model; receiving second results that are generated by the ML model, based on feeding the synthetic data to the inference endpoint of the ML model; conducting statistical analysis, based at least in part on the first results and the second results; determining whether the user data was used for training the ML model, based at least in part on conducting the statistical analysis; and causing to display an indication of the determination as to whether the user data was used for training the ML model. In an example, conducting the statistical analysis comprises: generating a user performance metric that is based at least in part on the first results; generating a synthetic performance metric that is based at least in part on the second results; and conducting the statistical analysis, based at least in part on the user performance metric and the synthetic performance metric. In an example, the user data comprises (i) a user input feature that was previously fed to the ML model and (ii) a user output feature that was previously generating by the ML model, based on feeding the user input feature to the ML model, and wherein generating the user performance metric comprises: generating a user recommendation error, based at least in part on a difference between the user output feature and the first results; and generating the user performance metric that is a function of the user recommendation error.

In an example, a system comprises: one or more processors; and one or more non-transitory computer-readable media storing instructions, which, when executed by the system, cause the system to perform a set of actions including: generating statistical distribution of user data; generating synthetic data by sampling from the statistical distribution of the user data; feeding the user data and the synthetic data to an inference endpoint of a machine learning (ML) model; receiving first results that are generated by the ML model, based on feeding the user data to the inference endpoint of the ML model; receiving second results that are generated by the ML model, based on feeding the synthetic data to the inference endpoint of the ML model; conducting statistical analysis, based at least in part on the first results and the second results; determining whether the user data was used for training the ML model, based at least in part on conducting the statistical analysis; and causing to display an indication of the determination as to whether the user data was used for training the ML model. In an example, conducting the statistical analysis comprises: generating a user performance metric that is based at least in part on the first results; generating a synthetic performance metric that is based at least in part on the second results; and conducting the statistical analysis, based at least in part on the user performance metric and the synthetic performance metric. In an example, the user data comprises (i) a user input feature that was previously fed to the ML model and (ii) a user output feature that was previously generating by the ML model, based on feeding the user input feature to the ML model, and wherein generating the user performance metric comprises: generating a user recommendation error, based at least in part on a difference between the user output feature and the first results; and generating the user performance metric that is a function of the user recommendation error.

In an example, a non-transitory computer-readable medium includes instructions that when executed by one or more processors, cause a system including the one or more processors to perform operations including: feeding user data to an inference endpoint of a first machine learning (ML) model; feeding the user data to a production system including a second ML model; receiving first results from the first ML model, and second results from the production system; conducting statistical analysis, based at least in part on the first results and the second results; and determining whether the first ML model and the second ML model are the same, based at least in part on conducting the statistical analysis. In an example, the operations further include: causing to display an indication of the determination as to whether the first ML model and the second ML model are the same. In an example, conducting the statistical analysis comprises comparing the first results and the second results. In an example, determining whether the first ML model and the second ML model are the same comprises: in response to a non-significant statistical difference between the first results and the second results, determining that the first ML model and the second ML model are the same. In an example, determining whether the first ML model and the second ML model are the same comprises: in response to a significant statistical difference between the first results and the second results, determining that the first ML model and the second ML model are different. In an example, determining whether the first ML model and the second ML model are the same comprises one of: in response to a non-significant statistical difference between the first results and the second results, determining that the first ML model and the second ML model are the same, or in response to a significant statistical difference between the first results and the second results, determining that the first ML model and the second ML model are different.

In an example, feeding the user data to the inference endpoint of the first ML model comprises feeding the user data to the inference endpoint by bypassing a frontend system of the first ML model. In an example, feeding the user data to the production system comprises feeding the user data through a frontend system of the production system.

In an example, a method comprises: feeding user data to an inference endpoint of a first machine learning (ML) model; feeding the user data to a production system including a second ML model; receiving first results from the first ML model, and second results from the production system; conducting statistical analysis, based at least in part on the first results and the second results; and determining whether the first ML model and the second ML model are the same, based at least in part on conducting the statistical analysis. In an example, the method further comprises: causing to display an indication of the determination as to whether the first ML model and the second ML model are the same. In an example, conducting the statistical analysis comprises comparing the first results and the second results. In an example, determining whether the first ML model and the second ML model are the same comprises: in response to a non-significant statistical difference between the first results and the second results, determining that the first ML model and the second ML model are the same. In an example, determining whether the first ML model and the second ML model are the same comprises: in response to a significant statistical difference between the first results and the second results, determining that the first ML model and the second ML model are different. In an example, determining whether the first ML model and the second ML model are the same comprises one of: in response to a non-significant statistical difference between the first results and the second results, determining that the first ML model and the second ML model are the same, or in response to a significant statistical difference between the first results and the second results, determining that the first ML model and the second ML model are different. In an example, feeding the user data to the inference endpoint of the first ML model comprises feeding the user data to the inference endpoint by bypassing a frontend system of the first ML model. In an example, feeding the user data to the production system comprises feeding the user data through a frontend system of the production system.

In an example, a system comprises: one or more processors; and one or more non-transitory computer-readable media storing instructions, which, when executed by the system, cause the system to perform a set of actions including: feeding user data to an inference endpoint of a first machine learning (ML) model; feeding the user data to a production system including a second ML model; receiving first results from the first ML model, and second results from the production system; conducting statistical analysis, based at least in part on the first results and the second results; and determining whether the first ML model and the second ML model are the same, based at least in part on conducting the statistical analysis. In an example, conducting the statistical analysis comprises comparing the first results and the second results. In an example, determining whether the first ML model and the second ML model are the same comprises: in response to a non-significant statistical difference between the first results and the second results, determining that the first ML model and the second ML model are the same. In an example, determining whether the first ML model and the second ML model are the same comprises: in response to a significant statistical difference between the first results and the second results, determining that the first ML model and the second ML model are different.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a system configured to validate user data in training of a machine learning (ML) model.

FIG. 2A illustrates a table summarizing example decisions for an example value of a significance level alpha and example p-values for a first scenario, in which a system aims to verify that user data was not used to train a ML model.

FIG. 2B illustrates another table summarizing example decisions for an example value of a significance level alpha and example p-values for a second scenario, in which a system aims to verify that user data 104 was used to train a ML model.

FIG. 3 illustrates a system for validating a model inference endpoint that is provided to an auditor auditing a ML model behind the model inference endpoint, wherein the validation is performed to verify that the ML model behind the model inference endpoint is indeed used in a production system.

FIG. 4A illustrates a method for verifying whether user data was used to train a ML model.

FIG. 4B illustrates a method for validating a model inference endpoint that is provided to an auditor auditing a ML model behind the model inference endpoint, wherein the validation is performed to verify that the ML model behind the model inference endpoint is indeed used in a production system.

FIG. 5 depicts a simplified diagram of a distributed system for implementing certain aspects.

FIG. 6 is a simplified block diagram of one or more components of a system environment by which services provided by one or more components of an embodiment system may be offered as cloud services, in accordance with certain aspects.

FIG. 7 illustrates an example computer system that may be used to implement certain aspects.

### DETAILED DESCRIPTION

Machine learning models are heavily influenced by the data they are trained on. For example, as described above, a recommendation system comprises a machine learning (ML) model that provides suggestions or recommendations for items to users. The ML model may be trained based on past interactions with users, and the recommendation system recommends new items to the users for consumption.

In today's society, user data sharing and data privacy are of concern. For example, due to privacy concerns, a user may not desire to have his or her data shared, or remembered by organizations (or ML models of the organizations) for a long period of time. Regulatory authorities also have framework for sharing and storing of user data. Merely as an example, General Data Protection Regulation (GDPR) is a European Union regulation on information privacy in the European Union (EU) and the European Economic Area (EEA), and GDPR has regulation to enhance individuals' control and rights over their personal information, and provides guidance on how personal data can be stored or shared by organizations.

Because training of a ML model involves use of large set of user data, it may be of interest to ensure that the training of ML models adhere to guidelines for retention of user data. Accordingly, in an example, the ML model may be audited, along with auditing of the training data used to train the model.

In an example, auditing of a dataset may be used to determine whether the dataset being provided to an auditor was used to train the model in question. For example, an auditor may be deployed by a regulating agency (as a part of an external audit) or by an organization itself (as a part of an internal audit), where the auditor is entrusted to verify if one or more ML models of the organization adheres to regulatory guidelines associated with retention of user data.

Described below are various examples techniques to verify whether a given dataset was or was not used to train a supervised learning model. For example, by exploiting a tendency of supervised learning models to overfit on their training data, these techniques enable an auditor to assess whether or not provided user data was indeed used to train a ML model. Such techniques are helpful both in confirming that an algorithm was trained on a given dataset, as well as confirming that a model is no longer influenced by data that should have been deleted. For example, in order to comply with the GDPR, organizations may not hold private user data past a certain time period. By utilizing the techniques described herein, a confirmation may be made that the ML model in question does not perform extraordinarily well on data that it should have been deleted, or poorly on data it was supposedly fitted to.

Merely as an example, assume a ML model that recommends items for consumption (such as audios, videos, shopping items, etc.). For example, a platform including the ML model may be a video providing platform that provides videos for viewing by users, an audio providing platform that provides audios for listening by users, a shopping platform that provides physical or virtual items for buying by users, and/or the like. Because of the large number of items provided by the platform, a user may be overwhelmed in selecting items for consumption. The ML model provides recommendations or suggestions for items that are most pertinent to a particular user. The ML model is trained to receive information about the user and/or past interactions of the user with the platform, and provide item recommendations to the user.

Also merely as an example, assume that a streaming platform is looking to recommend personalized videos to users in an effort to keep users watching on their platform. In an example, is may be desirable that the streaming platform deletes user data within a threshold period, such as within 30 days of collecting the user data. Such deletion may be to comply with one or more regulations governing data retention policies (such as regulation imposed by the GDPR) or maybe to comply with the organization's internal policies. In an example, an auditor may be charged with ensuring that the ML model is compliant with such data retention policies. This means that if a user went through a phase 3 months ago where the user was watching a lot of comedy movies, but since have not watched any or much movies in the comedy category, there should not be an overabundance of comedy movies on the user's recommendation page. Thus, if indeed the user data is not retained for more than 30 days, at this stage, recommendations to the user should not include an overabundance of comedy movies. The techniques described herein can be used to ascertain that the 3-month-old training data from the user is indeed deleted, and the ML model is no longer influenced by data older than the 30-day maximum retention period, for example.

In an example, two scenarios are described herein with respect to an operation of a data validation system described herein. In a first scenario (also referred to as scenario 1 in this disclosure), the data validation system tries to confirm that a specific set of user data was not used to train the ML model. For example, an auditor is assigned to audit the user data, and instructed to verify that the user data was not used to train the ML model. Here, the hypothesis is that the user data was not used to train the ML model, and the auditor aims to verify or confirm such a hypothesis.

In a second scenario (also referred to as scenario 2 in this disclosure), the data validation system tries to confirm that the user data was indeed used to train the ML model. For example, in this scenario, an auditor is given user data (e.g., by the organization operating and/or owning the ML model) and is told that the user data was used to train the ML model. The auditor now wants to confirm that the user data was indeed used to train the ML model. Here, the hypothesis is that the user data was used to train the ML model, and the auditor aims to verify such a hypothesis.

In an example, the dataset being validated (e.g., verified whether used to train a ML model or not) comprises interactions of a user with the ML model, and corresponding recommendations generated by the ML model. For example, assume a scenario where the ML model is a video recommender model recommending videos to its users. The user data comprises information about videos watched by the user over a period of time, a watch duration each time the user watches such videos, whether the user has rated and/or shared (such as with friends) the videos, whether the user has subscribed to one or more channels provided by the item recommendation platform, and/or any other interaction(s) that user may have had with the item recommendation platform over the period of time. In an example, the user data may further include demographic information about the user (such as an age, sex, education level, income level, political views, and/or geographical location of the user). In an example, the user data may further include interests of the user, where the user may prespecify one or more areas (such as politics, nature, comedy, etc.) that the user is most interested in viewing. In an example, the user data further includes recommendations provided by the ML model. The user data is denoted by Dᵤₛₑᵣ. In an example, the user data Dᵤₛₑᵣ includes data points (x,y), where x represents input features within user data Dᵤₛₑᵣ and y represents recommendation output of the ML model within user data Dᵤₛₑᵣ, as will be described below in further detail.

In an example, the data validation system comprises a synthetic data generator service to generate synthetic data from the user data. In an example, the synthetic data is sampled to be within the distribution of the user data. For example, the data points of the synthetic data may be generated through statistical sampling within the distribution of the user data, and selectively discarding any samples that coincide or overlap with the points of the user data. The synthetic data is denoted by D_{synth}. In an example, the synthetic data generator service obtains a sample of the user data Dᵤₛₑᵣ, and performs statistical analysis on Dᵤₛₑᵣ to estimate its probability distribution P{Dᵤₛₑᵣ(x,y)}. Subsequently, synthetic data generator service generates the synthetic dataset D_{synth}, with data points (x_i,y_i) sampled from the estimated distribution P{Dᵤₛₑᵣ(x,y)}. Thus, x_i represents the input features within the synthetic data D_{synth} and y_i represents recommendation output of the ML model within the synthetic data D_{synth}.

In an example, the user data and the synthetic data are transmitted to the ML model, e.g., via a model inference endpoint. The ML model processes the user data, and provides first results for the user data. Similarly, the ML model processes the synthetic data and provides second results for the synthetic data.

The first results corresponding to the user data may be in the form of recommendations, in case the ML model is configured to provide recommendations, as described above. For example, assume that the user data is Dᵤₛₑᵣ(x,y), where x represents the input features within Dᵤₛₑᵣ and y represents recommendation output of the ML model within Dᵤₛₑᵣ. Thus, the input features x of the user data is Dᵤₛₑᵣ is fed to the ML model via the model inference endpoint. In such a case, the first results corresponding to the user data is denoted as M(x), which is the output of the ML model for the input features x within the user data Dᵤₛₑᵣ.

The second results may similarly be in the form of recommendations. For example, assume that the synthetic data is D_{synth}(x_i,y_i), where x_i represents the input features within D_{synth} and y_i represents recommendation output of the ML model within D_{synth}. In such a case, the second results corresponding to the synthetic data may be denoted as M(x_i), which is the output of the ML model for the input features x_i within the synthetic data D_{synth}.

The first and second results (such as M(x) and M(x_i) described above) are processed by one or more evaluation services, and corresponding performance metrices are generated. For example, assume that “user performance metric” is generated based on the first results corresponding to the user data, and “synthetic performance metric” is generated based on the second results corresponding to the synthetic data.

In an example, each of the user performance metric and the synthetic performance metric is representative of (such as a function of) a loss function, which is based on an error of recommendation. For example, for the user data, an error of recommendation is represented by an absolute difference between (i) M(x) output by the ML model and (ii) recommendations y within the user data Dᵤₛₑᵣ.

For example, M(x) output by the ML model may include recommendation rating for a plurality of recommended items provided by the ML model based on the input feature x; and y of the user data Dᵤₛₑᵣ may also include previous rating of a plurality of previously recommended items based on the input feature x. For each item, a difference between the sets of recommendations M(x) and y ratings may be representative of the recommendation error, as described below in further detail. In an example, the user performance metric may be a function of a loss function, which in turn is based on the error of recommendation.

Similarly, the second result may include recommendations of videos M(x_i) output by the ML model, when the ML model 108 is fed with input features x_i of the synthetic data D_{synth}. In this case, an error of recommendation is represented by an absolute difference between (i) M(x_i) output by the ML model and (ii) recommendations y_i within the synthetic data D_{synth}. In an example, the synthetic performance metric may be a function of the error of recommendation.

The user performance metric and the synthetic performance metric are received by a statistical service. The statistical service performs one or more statistical tests, e.g., by comparing the performance metric and the synthetic performance metric, to determine if there is a significant difference between the two populations of the two performance metrices, and outputs statistical results.

In an example, by exploiting the tendency of supervised learning models to overfit on their training data, the statistical service enables accessing whether or not the user data was indeed used to train the ML model. For example, assume that the user data was indeed used previously to train the ML model. Then, due to the tendency of overfitting to the training data, the ML model is likely to output first results such that the recommendation error for the user performance metric is likely to be low. For example, if the user data was indeed used to train the ML model, then due to a tendency of overfitting to the training data, the output M(x) and the output y of the user data Dᵤₛₑᵣ are going to be somewhat similar (e.g., as the same input feature x is used to generate M(x) and y). This leads to a low error of recommendation corresponding to the user data, and consequently a low value of the user performance metric. However, because the ML model was definitely not trained on the synthetic data, the recommendation error for the performance metric and consequently the synthetic performance metric is likely to be high. This leads to a relatively high statistical difference between the user performance metric and the synthetic performance metric. Thus, statistically significant difference between the user performance metric and the synthetic performance metric is an indication that the user data was likely used for training the ML model.

On the other hand, any non-significant statistical difference between the user performance metric and the synthetic performance metric may be an indication that the user data was not likely used for training the ML model.

For the statistical tests conducted by the statistical service, a significance level alpha and a p-value may be used to determine whether a statistical difference between the user performance metric and the synthetic performance metric is significant, or non-significant. Subsequently, a decision is made (e.g., based on whether the statistical difference is significant or non-significant) as to whether the user data was used or not used to train the ML model, as described below in further detail.

In the data validation system described herein, a model inference endpoint is provided to an auditor operating the data validation system. For example, the auditor provides the user data and the synthetic data to the model inference endpoint. The model inference endpoint is “supposed” to be a path to the ML model. For example, during the audit process, the model inference endpoint is supposed to receive input features and provide the input features to the ML model for inferencing. However, in an example, the auditor wants to verify that the model inference endpoint is indeed a model inference endpoint of a ML model that is actually used in a production system. For example, in some corner cases, it may be possible that a malicious operator of the ML model provides a wrong model inference endpoint to the auditor. For example, in an auditor-operator (such as operator of the ML model) framework, a malicious operator may train a dummy ML model on compliant data, place the dummy ML model behind the model inference endpoint, and provide the compliant data alongside this model inference endpoint. Thus, audits of the dummy model behind the model inference endpoint would come as being complaint to relevant regulations. However, in practice, the malicious operator may never or seldom use this dummy ML model in the actual production system, and instead use another ML model for the production system that may not be complaint with the relevant regulations for which the audit is being performed. In this scenario, the auditor may be testing a ML model that is not used in the production system. Accordingly, described below is an inference endpoint validation system that can validate a model inference endpoint that is provided to an auditor auditing a ML model behind the model inference endpoint, wherein the validation is performed to verify that the ML model behind the model inference endpoint is indeed used in a production system.

For example, the auditor has access to the model inference endpoint provided by the operator of a first ML model to the auditor. The auditor has also access to the production system, which is a live platform, behind which a second ML model is operating. Access to the production system may be through a public network, such as the Internet. For example, the production system is open for public access, and the auditor accesses the production system like any other user of the platform would access the production system. In contrast, the auditor can directly access the model inference endpoint (e.g., by bypassing any frontend interface of the first ML model), based on privileges given by the operator specifically to the auditor for specifically auditing the first ML model. Here the auditor wants to verify whether the first ML model behind the model inference endpoint and the second ML model within the production system are the same (which would be an ideal case), or are different (which may be an indication of a malicious intent by the operator of the ML models).

In an example, the auditor feeds the same user data to the model inference endpoint and to the production system. A statistical service receives (i) first output from the first ML model operating behind the model inference endpoint, and (ii) second output from the second ML model within the production system. As described below in further detail, the statistical service correlates the first output and the second output, to determine if a difference between the first output and the second output is statistically significant or non-significant. In an example, if the difference is statistically significant, then the first ML model and the second ML model are likely different. On the other hand, if the difference is statistically non-significant, then the first ML model and the second ML model are likely the same (or are different, but trained similarly). This services the purpose validating the model inference endpoint by the auditor.

### Validating Use of Data in Training of Machine Learning Models

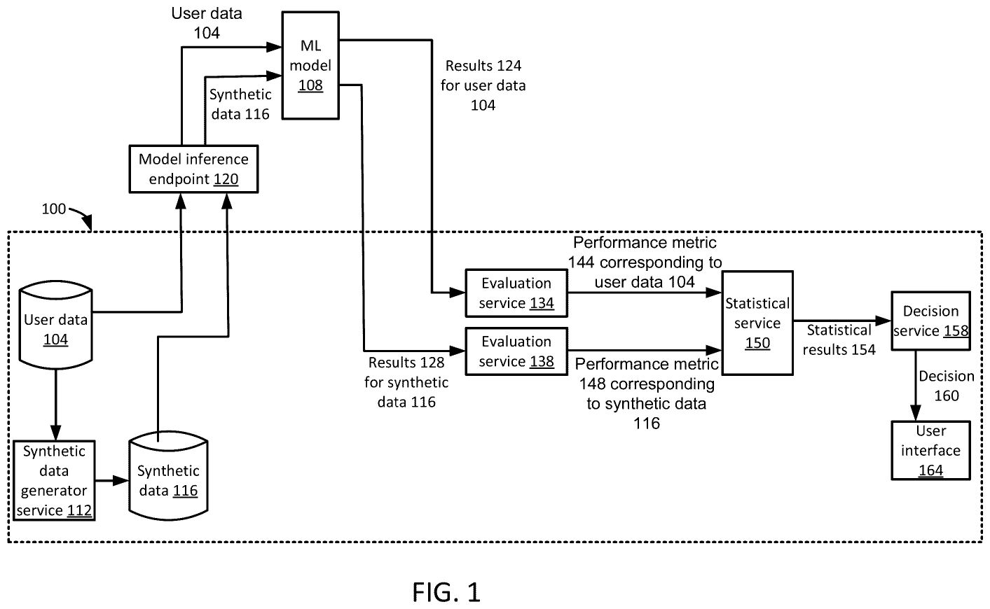

FIG. 1 illustrates a system 100 configured to validate user data in training of a ML model 108. As described above, the system 100 aims to infer whether one or more target users' data is being used (or has been used) to train the ML model 108. The system 100 receives user data 104, which may or may not have been used to train the ML model 108. The following two scenarios are described herein with respect to an operation of the system 100.

In a first scenario (also referred to as scenario 1 in this disclosure), the system 100 tries to confirm that the user data 104 was not used to train the ML model 108. For example, an auditor is assigned to audit the user data 104, and instructed to verify that the user data 104 was not used to train the ML model 108. Here, the hypothesis is that the user data 104 was not used to train the ML model 108, and the auditor aims to verify or confirm such a hypothesis. In an example, the auditor may be employed by a regulatory authority, e.g., to ensure that the ML model 108 complies with prevailing user data privacy regulations, and to ensure that the user data 104 is not used to train the ML model 108. In another example, the auditor may be employed by an organization operating or owning the ML model 108, e.g., as a part of an internal audit process to ensure that the ML model 108 complies with prevailing user data privacy regulations. In yet another example, any third-party actor (e.g., unrelated to the organization operating or owning the ML model 108) may operate one or more components of the system 100. The teaching of this disclosure is not limited by an actor operating the system 100, and/or an intension of such an actor operating the system 100.

In a second scenario (also referred to as scenario 2 in this disclosure), the system 100 tries to confirm that the user data 104 was indeed used to train the ML model 108. For example, in this scenario, an auditor is given user data 104 (e.g., by the organization operating and/or owning the ML model 108) and is told that the user data 104 was used to train the ML model 108. The auditor now wants to confirm that the user data 104 was indeed used to train the ML model 108. Here, the hypothesis is that the user data 104 was used to train the ML model 108, and the auditor aims to verify such a hypothesis.

In an example, the ML model 108 is part of a recommendation system, such as a ML model providing item recommendations to its users, where item recommendation may be in the form of audio recommendations, video recommendations, recommendations for buying physical or virtual products, or other types of recommendations for physical or virtual items. Other types of ML models may also be used instead of the ML model 108 providing recommendations.

In an example, the user data 104 comprises interactions of a user with the ML model 108, and corresponding recommendations generated by the ML model 108. For example, assume a scenario where the ML model 108 is a video recommender model recommending videos to its users. A user may like to watch comedy television series, and may watch such comedy series on an average most weekdays for about 30 minutes to an hour. The user data 104 comprises information about TV series and/or movies watched by the user over a period of time, a watch duration each time the user watches such TV series and/or movies, whether the user has rated (such as liked or disliked, or otherwise provided a rating) and/or shared (such as with friends) the watched TV series and/or movies, whether the user has subscribed to one or more channels provided by the item recommendation platform, and/or any other interaction(s) that user may have had with the item recommendation platform over the period of time. In an example, the user data 104 may further include demographic information about the user (such as an age, sex, education level, income level, political views, and/or geographical location of the user). In an example, the user data 104 may further include interests of the user, where the user may prespecify one or more areas (such as politics, nature, comedy, etc.) that the user is most interested in viewing.

In an example, the user data 104 further includes recommendations provided by the ML model 108. For example, the ML model 108 may recommend a plurality of videos to the user, and a recommendation level (e.g., a first video is most likely to be viewed by the user, a second video is somewhat likely to be viewed by the user, and a third video is least likely to be viewed by the user). The user data 104 further includes a plurality of items recommended to the user by the ML model 108, and a perceived or likely rating of each such item provided by the ML model 108.

The user data 104 is denoted by Dᵤₛₑᵣ. In an example, the user data Dᵤₛₑᵣ includes data points (x,y), where x represents the input features within user data Dᵤₛₑᵣ and y represents recommendation output of the ML model 108 within user data Dᵤₛₑᵣ, as will be described below in further detail. In an example and as described above, the input features x of the user data Dᵤₛₑᵣ may include interactions of the user with the ML model 108, such as one or more videos watched by the user, one or more ratings of such one or more videos provided by the user, a duration and/or frequency of each such video watched by the user, demographic information and/or interests of the user, etc. In an example and as described above, the output features y of the user data Dᵤₛₑᵣ may include a plurality of videos recommended to the user by the ML model 108, and a perceived or likely rating of each such videos provided by the ML model 108.

In an example, the system 100 comprises a synthetic data generator service 112 to generate synthetic data 116 from the user data 104. In an example, the synthetic data generator service 112 performs basic statistical analysis of the user data 104, e.g., to characterize its statistical distribution including one or more features present in the user data 104, such as user demographics, interests, interactions, viewing history, and/or the like. In an example, the synthetic data 116 is sampled to be within the distribution of the user data 104. In an example, although the distribution of the user data 104 and the synthetic data 116 are substantially similar, the synthetic data 116 may exclude one or more items that are too close to the user data 104. Thus, the data points within the synthetic data 116 and the corresponding data points within the user data 104 are within the same distribution, but not overlapping with each other. In an example, the data points of the synthetic data 116 may be generated through statistical sampling within the distribution of the user data 104, and selectively discarding any samples that coincide or overlap with the points of the user data 104. In an example, the synthetic data 116 comprises possible interactions of a synthetic or dummy user with the ML model 108, demographic information about the synthetic user, interests of the synthetic user, etc., synthetically generated recommendations that are most likely to be provided by the ML model 108 based on the interactions of the synthetic user with the ML model 108.

The synthetic data 116 is denoted by D_{synth}. In an example, the synthetic data generator service 112 obtains a sample of the user data Dᵤₛₑᵣ, and performs statistical analysis on Dᵤₛₑᵣ to estimate its probability distribution P{Dᵤₛₑᵣ(x,y)}, where x represents the input features within Dᵤₛₑᵣ and y represents recommendation output of the ML model 108 within Dᵤₛₑᵣ.

Subsequently, synthetic data generator service 112 generates the synthetic dataset D_{synth} (which is the synthetic data 116) of size N, with data points (x_i,y_i) sampled from the estimated distribution P{Dᵤₛₑᵣ(x,y)}. Thus, (x,y) are data points of the user data Dᵤₛₑᵣ, and (x_i,y_i) are data points of the synthetic data D_{synth}, where (x,y) and (x_i,y_i) have the same distribution, but do not overlap on each other. Thus, x_i represents the input features within the synthetic data D_{synth} and y_i represents recommendation output of the ML model 108 within the synthetic data D_{synth}.

In an example, the user data 104 and the synthetic data 116 are transmitted to the ML model 108, e.g., via a model inference endpoint 120. Thus, the user data 104 and the synthetic data 116 are passed through an application programming interface (API) for inference by the ML model 108. The model inference endpoint 120 and the ML model 108 are illustrated to be external to the system 100, although one or both these components may be a part of the system 100.

The ML model 108 processes the user data 104, and provides results 124 for the user data 104. Thus, the ML model provides inference results 124, based on an input in the form of the user data 104. Similarly, the ML model 108 processes the synthetic data 116 and provides results 128 for the synthetic data 116.

The results 124 may be in the form of recommendations, in case the ML model is configured to provide recommendations, as described above. For example, assume that the user data is Dᵤₛₑᵣ(x,y), where x represents the input features within Dᵤₛₑᵣ and y represents recommendation output of the ML model 108 within Dᵤₛₑᵣ. Thus, the input features x of the user data is Dᵤₛₑᵣ is fed to the ML model 108 via the model inference endpoint 120. In such a case, the results 124 corresponding to the user data 104 is denoted as M(x), which is the output of the ML model 108 for the input features x within the user data Dᵤₛₑᵣ.

The results 128 may similarly be in the form of recommendations. For example, assume that the synthetic data is D_{synth} (x_i,y_i), where x_i represents the input features within D_{synth} and y_i represents recommendation output of the ML model 108 within D_{synth}. In such a case, the results 128 corresponding to the synthetic data 116 may be denoted as M(x_i), which is the output of the ML model 108 for the input features x_i within the synthetic data D_{synth}.

The results 124 (such as M(x) described above) are processed by an evaluation service 134, and similarly, the results 128 (such as M(x_i) described above) are processed by an evaluation service 138. In an example, a same evaluation service may be used to process both results 124, and 128.

In an example, each evaluation service 134, 138 respectively determines performance metrices 144, 148, respectively, associated with the results 124, 128, respectively. For example, the evaluation service 134 processes the result 124, to generate the performance metric 144; and the evaluation service 138 processes the result 128, to generate the performance metric 148.

In an example, each performance metric is representative of (such as a function of) a loss function, which is based on an error of recommendation. For example, the results 124 may include recommendations of videos M(x) output by the ML model 108, when the ML model 108 is fed with input features x of the user data Dᵤₛₑᵣ. In this case, an error of recommendation is represented by an absolute difference between (i) M(x) output by the ML model 108 and (ii) recommendations y within the user data Dᵤₛₑᵣ. For example, M(x) output by the ML model 108 may include recommendation rating for a plurality of recommended items provided by the ML model 108 based on the input feature x, and y of the user data Dᵤₛₑᵣ may also include previous rating of a plurality of previously recommended items based on the input feature x. For each item, a difference between the two ratings may be representative of the recommendation error.

Merely as an example, assume that a first video is recommended in both M(x) and y, and both have a high rating for this first video. Then the error of recommendation corresponding to the first video is zero.

In another example, assume that a second video is recommended with a high rating in M(x) and a low rating in y. Then the error of recommendation corresponding to the second video is calculated based on the difference between the two ratings.

In yet another example, assume that a third video is recommended with a high rating in M(x) and not recommended in y. Then the error of recommendation corresponding to the third video is calculated based on a difference between a high rating and a zero rating.

In a further another example, assume that a fourth video is recommended with a low rating in y and not recommended in M(x). Then the error of recommendation corresponding to the fourth video is calculated based on a difference between a low rating and a zero rating.

In an example, the error of recommendation corresponding to the results 124 may be a summation of all such differences in ratings. In an example, the performance metric 144 may be a function of a loss function, which in turn is based on the error of recommendation. In an example, the performance metric 144 may be an appropriate function, such as a mean square function or a F1-score function, although other types of functions for the performance metric 144 may also be used.

Similarly, the result 128 may include recommendations of videos M(x_i) output by the ML model 108, when the ML model 108 is fed with input features x_i of the synthetic data D_{synth}. In this case, an error of recommendation is represented by an absolute difference between (i) M(x_i) output by the ML model 108 and (ii) recommendations y_i within the synthetic data D_{synth}. For example, M(x_i) output by the ML model 108 may include recommendation rating for a plurality of recommended items provided by the ML model 108, and y_i of the synthetic data may also include rating of a plurality of recommended items. For each item, a difference between the two ratings may be representative of the recommendation error for the synthetic data D_{synth}, similar to the discussion above with respect to the user data Dᵤₛₑᵣ. In an example, the performance metric 144 may be a function of the error of recommendation, such as a mean square function or a F1-score function, although other types of functions of the performance metric 144 may also be used.

In an example, each of the recommendation errors associated with the performance metrices 144, 148 may be an N-dimensional array, where N is a number of items recommended by the ML model 108 in the results 124 and 128. Each element in this N-dimensional array is an absolute difference between a rating predicted within the result 124 or 128, and the actual rating (e.g., as provided by the user or the synthetic user, as described above).

For the above-described example where the user data 104 is denoted by Dᵤₛₑᵣ and the synthetic data 116 is denoted by D_{synth}, the performance metric 144 is denoted by:

$${L}_{user} = \frac{1}{\vert {D}_{user} \vert} {\sum }_{( x , y ) ∈ {D}_{user}} l ( M ( x ) , y ) , \qquad Equation 1$$

where function l is a loss function associated with the results 124, y is the output of the ML model 108 as indicated by the user data 104, and M(x) is the actual output of the ML model 108 when the ML model 108 is fed data points x of the user data Dᵤₛₑᵣ during the testing of the ML model 108 by the system 100. The loss function is based on the above-described error of recommendation associated with the user data.

Similarly, the performance metric 148 is denoted by:

$${L}_{synth} = \frac{1}{\vert {D}_{synth} \vert} {\sum }_{( x\_i , y\_i ) ∈ {D}_{synth}} l ( M ( x\_i ) , y\_i ) , \qquad Equation 2$$

where y_i is the output of the ML model 108 as indicated by the synthetic data 116, and M(x_i) is the actual output of the ML model 108 when the ML model 108 is fed data points x_i of the synthetic data D_{synth}. The loss function/is based on the above-described error of recommendation associated with the user data.

The performance metrices 144, 148 are received by a statistical service 150. The statistical service 150 performs one or more statistical tests, e.g., by comparing the performance metrices 144, 148, determines if there is a significant difference between the two populations of the performance metrices 144, 148, and outputs statistical results 154. Although the statistical service 150 operates on the performance metrices 144, 148 in the example of FIG. 1, in another example, the statistical service 150 may also operate on the results 124 and 128.

In an example, by exploiting the tendency of supervised learning models (such as the ML model 108) to overfit on their training data, the statistical service 150 enables accessing whether or not the user data 104 was indeed used to train the ML model 108. For example, assume that the user data 104 was indeed used previously to train the ML model 108. Then, due to the tendency of overfitting to the training data, the ML model 108 is likely to output results 124 such that the recommendation error for the performance metric 144 is likely to be low. For example, if the user data 104 was indeed used to train the ML model 108, then due to a tendency of overfitting to the training data, the output M(x) of the ML model 108 and the output y of the user data Dᵤₛₑᵣ are going to be somewhat similar (e.g., as the same input feature x is used to generate M(x) and y). This leads to a low error of recommendation corresponding to the user data, and consequently a low value of Lᵤₛₑᵣ of equation 1. However, because the ML model 108 was definitely not trained on the synthetic data 116 (as the synthetic data 116 was generated by the auditor through the synthetic data generator service 112), the recommendation error for the performance metric 148 and consequently the performance metric L_{synth} of equation 2 is likely to be high. This leads to a relatively high statistical difference between Lᵤₛₑᵣ of equation 1 and L_{synth} of equation 2. Thus, statistically significant difference between the performance metrices 144, 148 (or between the distributions of the performance metrices 144, 148) is an indication that the user data 104 was likely used for training the ML model 108.

On the other hand, if the user data 104 was not used to train the ML model 108, the ML model 108 may not have any inherent inclination to make any of the results 124 or 128 more accurate. Thus, there may not be significant statistical difference between the performance metrices 144 (Lᵤₛₑᵣ of equation 1) and 148 (L_{synth} of equation 2), or between the distributions of the performance metrices 144, 148. Thus, any non-significant statistical difference between the performance metrices 144 (Lᵤₛₑᵣ of equation 1) and 148 (L_{synth} of equation 2) may be an indication that the user data 104 was not likely used for training the ML model 108.

For the statistical tests conducted by the statistical service 150, a significance level alpha or α is a probability of rejecting a null hypothesis, when in fact the hypothesis is correct. In an example, the alpha value may be preconfigured to an appropriate value, e.g., based on a significance level desired by the auditor. In an example, the hypothesis may be that there is a significant statistical difference between the performance metrices 144 and 148 (or there is no significant statistical difference between the performance metrices 144 and 148), based on the scenario 1 or 2 (described above) being tested.

In an example, the auditor of the system 100 may preselect the alpha, based on a desired confidence level of the statistical inference drawn by the statistical service 150. For example, the smaller is the alpha, the more statistical confidence is on the decision 160 (as there is a small chance that the inference by the statistical service 150 and/or the decision service 158 is not correct). Merely as an example, the alpha may be set to a relatively small value of 0.01, so that the auditor can be more confident that the results they have obtained from the system 100 are reasonably or fairly accurate.

The statistical test conducted by the statistical service 150 (such as a t-test conducted by the statistical service 150) generates statistical results 154, which includes p-value for the statistical test. The lower the p-value, the greater the statistical significance between the errors. If the p-value is lower than the alpha and assuming that the alpha is 0.01 (merely as an example), it can be inferred that the system 100 is confident at an alpha of 1% that the differences between the performance metrices 144 and 148 are statistically significant.

The system 100 further includes a decision service 158 that received the statistical results 154, and renders a decision 160 as to whether the user data 104 was used or not used to train the ML model 108. In an example, an indication of the decision 160 is displayed on a user interface (UI) 164.

Under the above-described scenario 1 that deals with the user data 104 not used to train the ML model 108, it is expected that the statistical difference is not significant for the hypothesis to be true. For scenario 2 that deals with the user data 104 being in fact used to train the ML model, it is expected that the statistical difference is significant for the hypothesis to be true.

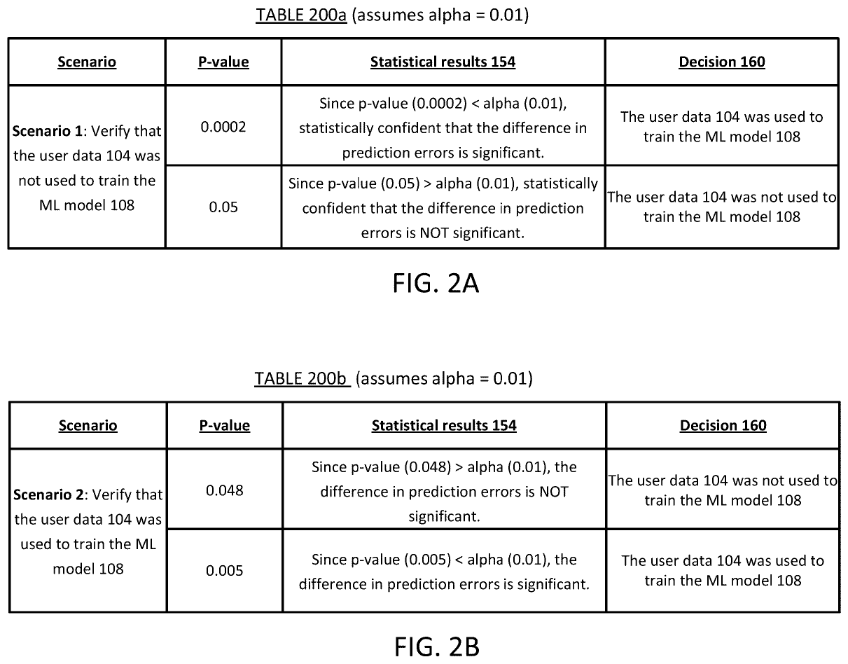

FIG. 2A illustrates a table 200a summarizing example decisions 160 for an example value of alpha (where alpha is assumed to be 0.01) and example p-values for a first scenario, in which the system 100 aims to verify that the user data 104 was not used to train the ML model 108. FIG. 2B illustrates a table 200b summarizing example decisions 160 for an example value of alpha (where alpha is assumed to be 0.01) and example p-values for a second scenario, in which the system 100 aims to verify that the user data 104 was used to train the ML model 108. The tables 200a and 200b will be evident, based on the description above.

### Validating a Model Inference Endpoint During an Audit of a Machine Learning Model

In FIG. 1, it is assumed that the model inference endpoint 120 is provided to an auditor operating the system 100. For example, the auditor provides the user data 104 and the synthetic data 116 to the model inference endpoint 120. The model inference endpoint 120 is “supposed” to be a path to the ML model 108. For example, the model inference endpoint 120 is supposed to receive input features and provide the input features to the ML model 108 for inferencing. Thus, the model inference endpoint 120 is supposed to provide the user data 104 and the synthetic data 116 to the ML model 108, and the ML model 108 is supposed to provide the results 124 and 128.

However, in an example, the auditor wants to verify that the model inference endpoint 120 is indeed a model inference endpoint of a ML model that is actually used in a production system. For example, in some corner cases, it may be possible that a malicious operator of the ML model 108 provides a wrong model inference endpoint to the auditor.

For example, in an auditor-operator (such as operator of the ML model 108) framework, a malicious operator may train a dummy ML model on compliant data, place the dummy ML model behind the model inference endpoint 120, and provide the compliant data alongside this model inference endpoint 120. Thus, audits of the dummy model behind the model inference endpoint 120 would come as being complaint to relevant regulations. However, in practice, the malicious operator may never or seldom use this dummy ML model in the actual production system, and instead use another ML model for the production system that may not be complaint with the relevant regulations for which the audit is being performed. In this scenario, the auditor may be testing a ML model that is not used in the production system.

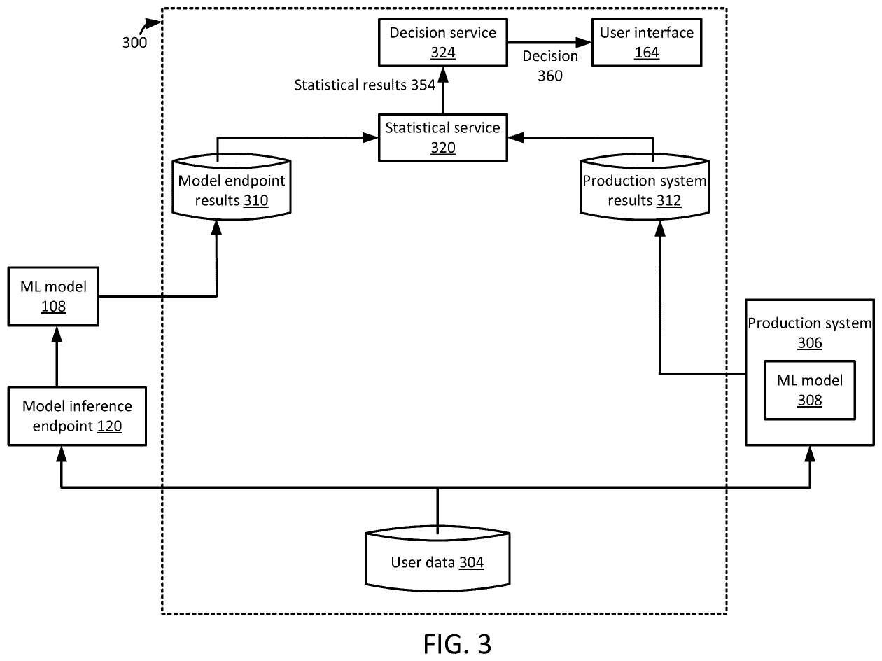

FIG. 3 illustrates a system 300 for validating a model inference endpoint (such as the model inference endpoint 120 of the system 100 of FIG. 1) that is provided to an auditor auditing a machine learning (ML) model behind the model inference endpoint, wherein the validation is performed to verify that the ML model behind the model inference endpoint is indeed used in a production system.

In an example, in the system 300, the auditor has access to the model inference endpoint 120 provided by the operator of the ML model 108 to the auditor, e.g., as described above with respect to FIG. 1. The auditor has also access to the production system 306, which is a live platform, behind which the ML model 108 is supposedly operating. Access to the production system 306 may be through a public network, such as the Internet. For example, the production system 306 is open for public access (e.g., as a part of paid or free subscription), and the auditor accesses the production system 306 like any other user of the platform would access the production system 306. In contrast, the auditor can directly access the model inference endpoint 120 (e.g., by bypassing any frontend interface of the ML model 108), based on privileges given by the operator specifically to the auditor for specifically auditing the ML model 108.

In an example, the auditor feeds user data 304 to the production system 306 and to the model inference endpoint 120. In an example, the auditor may not be able to directly feed user data 304 to the production system 306. Rather, the auditor may create dummy users (such as sock puppets or autonomous users) that interact with the production system 306. In any case, the same user data is fed to the production system 306 and to the model inference endpoint 120. For example, dummy users may be formed, and the user data 304 may be fed to the production system 306 using the dummy users.

There is the ML model 108 being executed behind the model inference endpoint 120, and there is another ML model 308 being executed as a part of the production system 306. The auditor operating the system 300 aims to verify that the ML models 108 and 308 are the same ML models. This in turn confirms that the model inference endpoint 120 provided to the auditor of the system 100 is indeed the correct model inference endpoint, and further confirms that the ML model 108 behind the model inference endpoint 120 is indeed used in the production system 306.

In an example, in the system 300, user data 304 is fed to both the model inference endpoint 120 and the production system 306. The user data 304 may be same as the user data 104 of FIG. 1, or may be different. In an example, the user data 304 may be synthetically generated by sampling from a data distribution of the user data 104 of FIG. 1. In an example, the user data 304 may have been verified to be used for training the ML model 108. In another example, the user data 304 may not have been used for training the ML model 108. The teaching of this disclosure is not limited to any specific type of the user data 304.

The user data 304 is received by the ML model 108 through the model inference endpoint 120, and the ML model 108 outputs inferences, labelled as model endpoint results 310 in FIG. 3. Similarly, the user data 304 is received by the ML model 308 of the production system 306, and the ML model 308 outputs inferences, labelled as production system results 312 in FIG. 3

If the ML models 108 and 308 are the same, then the model endpoint results 310 and the production system results 312 may be statistically similar or the same. The system 300 comprises a statistical service 320 receiving the model endpoint results 310 and the production system results 312, conducting statistical analysis on the model endpoint results 310 and the production system results 312, and generating statistical results 354. The statistical results 354 comprises a preconfigured significance level alpha and a p-value for a statistical test conducted on the model endpoint results 310 and the production system results 312.

Conducting the statistical analysis on the model endpoint results 310 and the production system results 312 provide a certain degree of statistical significance on whether the distributions of these two predictions come from the same underlying distribution. For example, if the underlying ML model producing the results 310 and 312 is the same or similarly trained (that is, if the ML models 108 and 308 are the same or similarly trained), then the statistical distributions of the results 310 and 312 may also be similar to one another.

The statistical similarity between the model endpoint results 310 and the production system results 312 may be determined by the statistical service 320 using one or more statistical techniques, such as Kernel Density Estimation technique, Peacock test, Fasano and Franceschini test, Kullback-Leiber (KL) Divergence test, Student's T-Tests, Kolmogorov-Smirnov test, Mann-Whitney U test, Chi-Square test, and/or the like.

For example, as described above, the statistical service 320 may output statistical results 354 including a significance level alpha and a p-value. Based on comparing the significance level alpha and a p-value, a decision service 324 may conclude whether the model endpoint results 310 and the production system results 312 are statistically similar.

For example, if the p-value is less than the alpha, it may be concluded that the difference between the model endpoint results 310 and the production system results 312 are statistically significant. This implies that the ML model 108 and the ML model 308 are different.

On the other hand, if the p-value is more than the alpha, it may be concluded that the difference between the model endpoint results 310 and the production system results 312 is statistically not significant. This implies that the ML model 108 and the ML model 308 are the same, or are similarly trained.

The decision service 324 may provide a decision 360 indicating whether the ML model 108 and the ML model 308 are the same or are similarly trained, or whether the ML model 108 and the ML model 308 are different. The UI 164 (or a different UI) may provide an indication of such a determination.

### Methodologies

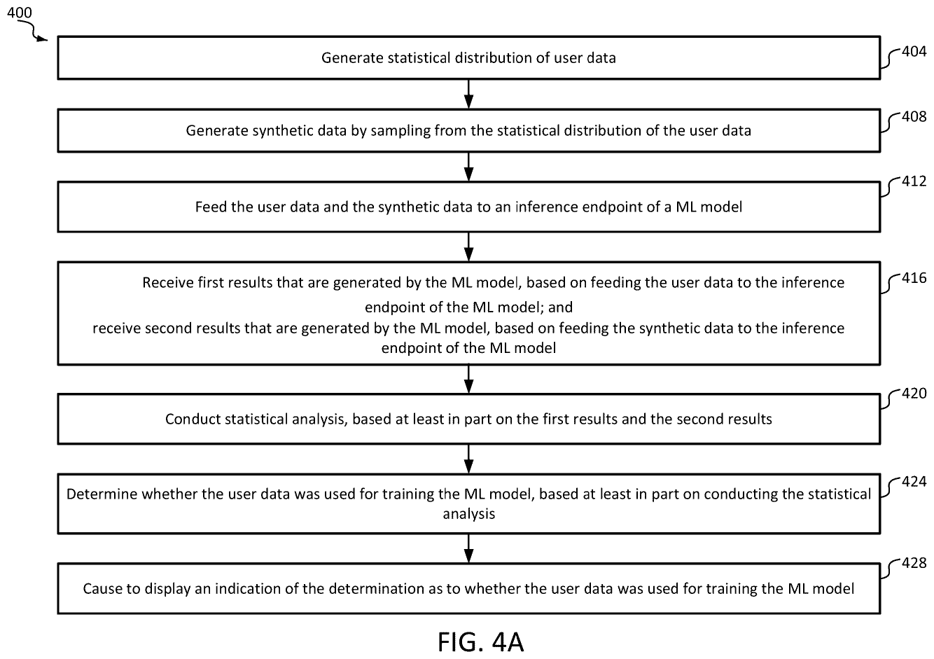

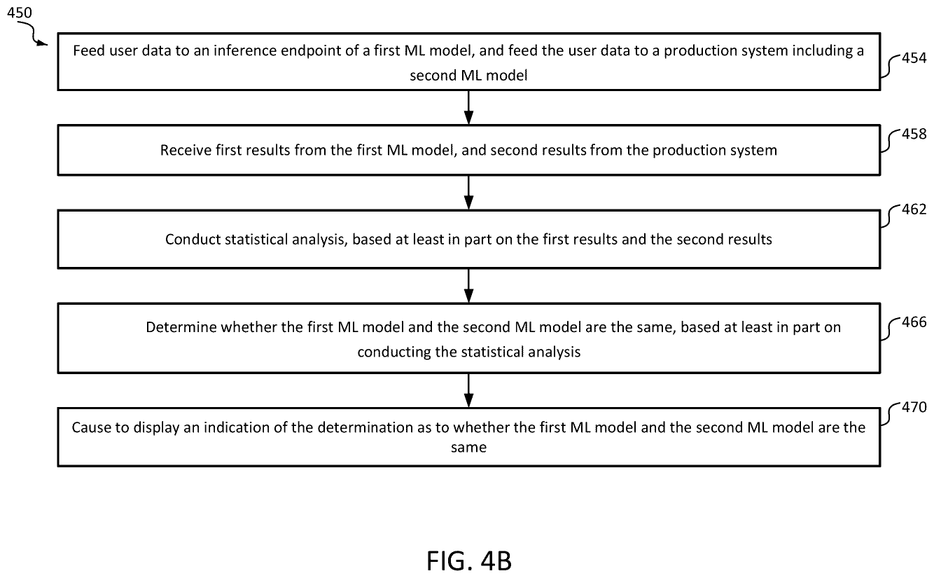

FIG. 4A illustrates a method 400 for verifying whether user data was used to train a ML model. In an example, the verification is carried out by the system 100 of FIG. 1.

At 404, a dataset comprising user data (such as user data 104) is accessed, and a statistical distribution of the user data is generated. At 408, synthetic data (such as synthetic data 116) is generated, e.g., by sampling from the statistical distribution of the user data. For example, the data points of the synthetic data may be generated through statistical sampling within the distribution of the user data, and selectively discarding any samples that coincide or overlap with the data points of the user data. At 412, the user data and the synthetic data are fed to an inference endpoint of a ML model (such as the model inference endpoint 120 of the ML model 108).

At 416, first results (such as results 124) are received, where the first results are generated by the ML model, based on feeding the user data to the inference endpoint of the ML model. Also, second results (such as results 128) are received, where the second results are generated by the ML model, based on feeding the synthetic data to the inference endpoint of the ML model.

At 420, statistical analysis is conducted (e.g., by the statistical service 150), based at least in part on the first results and the second results. For example, the evaluation services 134, 138 respectively generates performance metrices 144, 148, based on the first results 124 and second results 128, respectively. The statistical analysis is conducted by comparing the performance metrices 144, 148, and statistical results 154 (e.g., comprising a preconfigured significance level alpha and the p-value of the statistical analysis) are output by the statistical service 150.

At 424, a determination is made (e.g., by the decision service 158) as to whether the user data was used for training the ML model, based at least in part on conducting the statistical analysis. For example, the determination is made based on the statistical results 154 output by the statistical service 150. At 428, an indication of the determination as to whether the user data was used for training the ML model is caused to be displayed on a UI, such as the UI 164.

FIG. 4B illustrates a method 450 for validating a model inference endpoint (such as the model inference endpoint 120 of the system 100 of FIG. 1) that is provided to an auditor auditing a ML model behind the model inference endpoint, wherein the validation is performed to verify that the ML model behind the model inference endpoint is indeed used in a production system.

At 454, same user data (such as user data 304 of FIG. 3) is fed to an inference endpoint of a first ML model and to a production system including a second ML model. At 458, first results (e.g., model endpoint results 310) are received from the first ML model, and second results (e.g., production system results 312) are received from the production system.

At 462, statistical analysis is conducted (e.g., by the statistical service 320), based at least in part on the first results and the second results. At 466, a determination is made (e.g., by the decision service 324) as to whether the first ML model and the second ML model are the same, based at least in part on the statistical analysis. At 470, an indication of the determination as to whether the first ML model and the second ML model are the same is caused to be displayed on a UI (such as the UI 164).

### Computer System Architecture

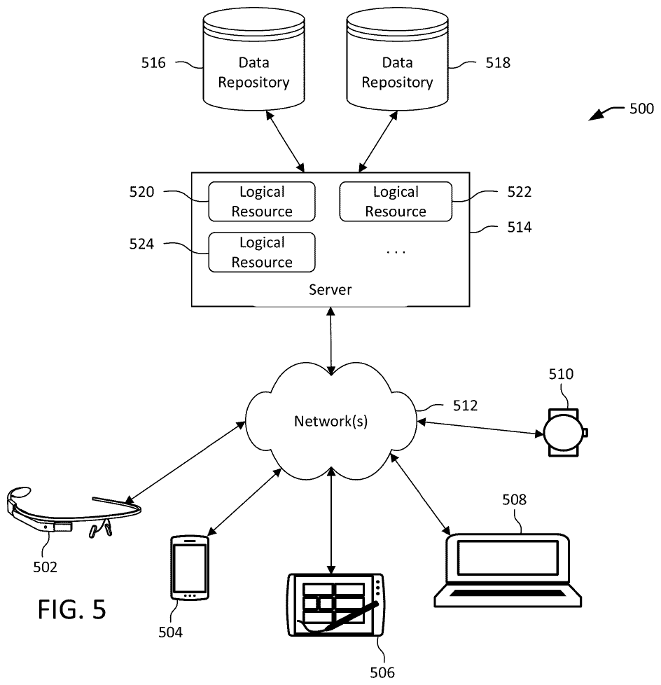

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for validating use of data in training of machine learning models and/or validating a model inference endpoint during an audit of a machine learning model.

In certain aspects, server 514 may also provide other services or software applications that can include non-virtual and virtual environments. In some aspects, these services may be offered as web-based or cloud services, such as under a Software as a Service (SaaS) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for validating use of data in training of machine learning models and/or validating a model inference endpoint during an audit of a machine learning model in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 514 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for validating use of data in training of machine learning models and/or validating a model inference endpoint during an audit of a machine learning model. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

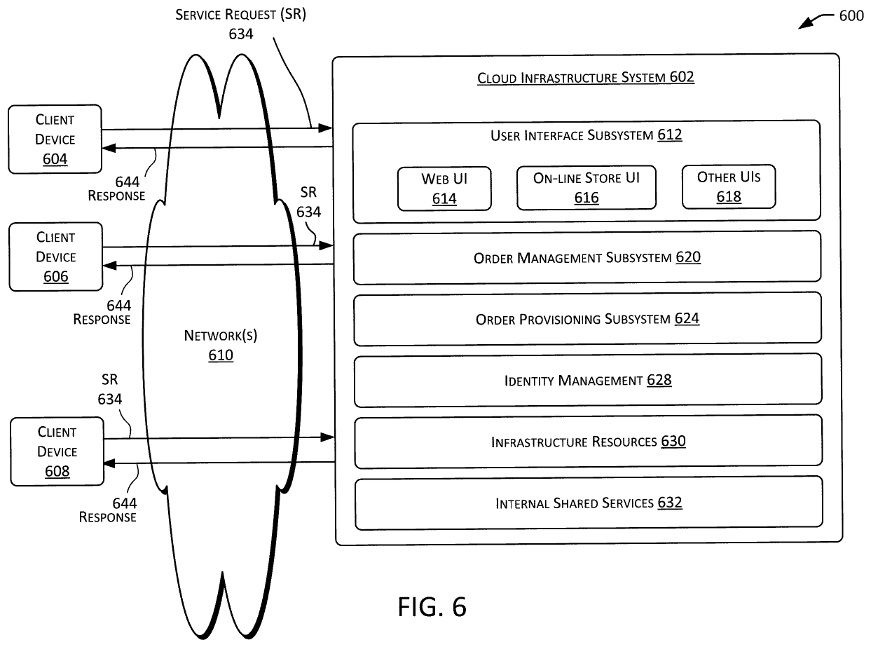

FIG. 6 is a simplified block diagram of a cloud-based system environment in which use of data in training of machine learning models is validated and/or a model inference endpoint during an audit of a machine learning model is validated, in accordance with certain aspects. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 512. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to.

In certain aspects, such as the embodiment depicted in FIG. 6, cloud infrastructure system 602 may comprise an order management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been preconfigured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

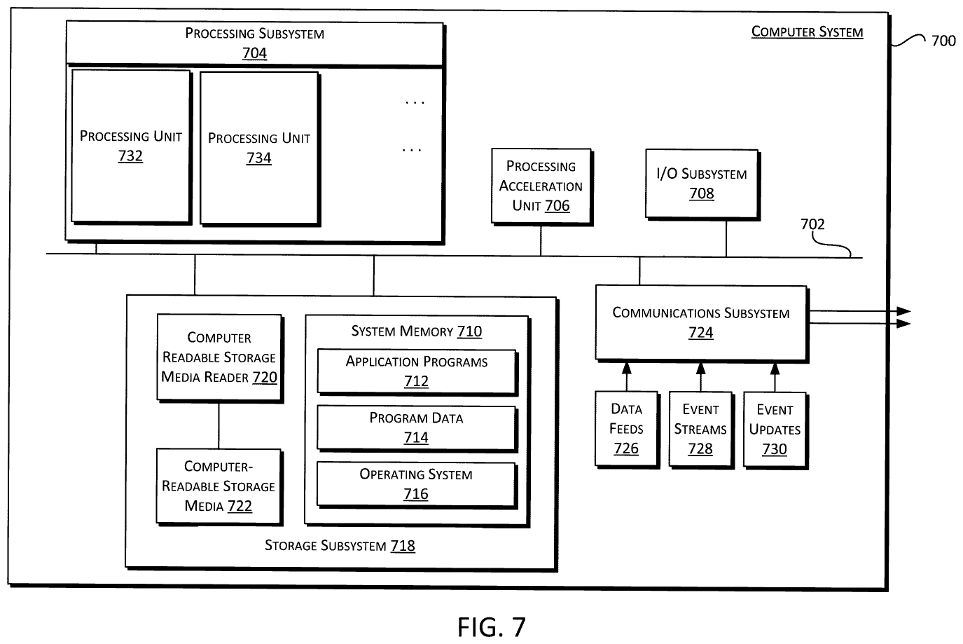

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices.

Communication subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communication subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system including the one or more processors to perform operations including:
generating statistical distribution of user data;
generating synthetic data by sampling from the statistical distribution of the user data;
feeding the user data and the synthetic data to an inference endpoint of a machine learning (ML) model;
receiving first results that are generated by the ML model, based on feeding the user data to the inference endpoint of the ML model;
receiving second results that are generated by the ML model, based on feeding the synthetic data to the inference endpoint of the ML model;
conducting statistical analysis, based at least in part on the first results and the second results;
determining whether the user data was used for training the ML model, based at least in part on conducting the statistical analysis; and
causing to display an indication of the determination as to whether the user data was used for training the ML model.

2. The non-transitory computer-readable medium of claim 1, wherein conducting the statistical analysis comprises:
generating a user performance metric that is based at least in part on the first results;
generating a synthetic performance metric that is based at least in part on the second results; and
conducting the statistical analysis, based at least in part on the user performance metric and the synthetic performance metric.

3. The non-transitory computer-readable medium of claim 2, wherein the user data comprises (i) a user input feature that was previously fed to the ML model and (ii) a user output feature that was previously generating by the ML model, based on feeding the user input feature to the ML model, and wherein generating the user performance metric comprises:
generating a user recommendation error, based at least in part on a difference between the user output feature and the first results; and
generating the user performance metric that is a function of the user recommendation error.

4. The non-transitory computer-readable medium of claim 2, wherein the synthetic data comprises (i) a synthetic input feature and (ii) a synthetic output feature, and wherein generating the user performance metric comprises:
generating a synthetic recommendation error, based at least in part on a difference between the synthetic output feature and the second results; and
generating the synthetic performance metric that is a function of the synthetic recommendation error.

5. The non-transitory computer-readable medium of claim 2, wherein:
conducting the statistical analysis comprises comparing the user performance metric with the synthetic performance metric; and
determining whether the user data was used for training the ML model comprises:
in response to a significant statistical difference between the user performance metric and the synthetic performance metric, determining that the user data was used for training the ML model.

6. The non-transitory computer-readable medium of claim 2, wherein:
conducting the statistical analysis comprises comparing the user performance metric with the synthetic performance metric; and
determining whether the user data was used for training the ML model comprises:
in response to a non-significant statistical difference between the user performance metric and the synthetic performance metric, determining that the user data was not used for training the ML model.

7. The non-transitory computer-readable medium of claim 2, wherein:
conducting the statistical analysis comprises (i) comparing the user performance metric with the synthetic performance metric using a statistical test, wherein the statistical test uses a significance level alpha, and (ii) generating a p-value from the statistical test; and
determining whether the user data was used for training the ML model comprises:
comparing the significance level alpha with the p-value, to determine whether the user data was used for training the ML model.

8. The non-transitory computer-readable medium of claim 7, wherein determining whether the user data was used for training the ML model comprises:
in response to the p-value being lower than the significance level alpha, determining that the user data was used for training the ML model.

9. The non-transitory computer-readable medium of claim 7, wherein determining whether the user data was used for training the ML model comprises:
in response to the p-value being higher than the significance level alpha, determining that the user data was not used for training the ML model.

10. The non-transitory computer-readable medium of claim 1, wherein the ML model is a recommender model that provides recommendation for one or more of videos, audios, or physical or virtual items for shopping.

11. The non-transitory computer-readable medium of claim 1, wherein the user data is first user data, wherein the ML model is a first ML model, and wherein the operations further include:
feeding second user data to the inference endpoint of the first ML model;
feeding the second user data to a production system that includes a second ML model;
receiving (i) third results from the first ML model, and (ii) fourth results from the production system;
conducting statistical analysis, based at least in part on the third results and the fourth results;
determining whether the first ML model and the second ML model are the same, based at least in part on conducting the statistical analysis; and
causing to display an indication of the determination as to whether the first ML model and the second ML model are the same.

12. The non-transitory computer-readable medium of claim 11, wherein:
conducting the statistical analysis comprises comparing the third results and the fourth results; and
determining whether the first ML model and the second ML model are the same comprises:
in response to a non-significant statistical difference between the third results and the fourth results, determining that the first ML model and the second ML model are the same.

13. The non-transitory computer-readable medium of claim 11, wherein:
conducting the statistical analysis comprises comparing the third results and the fourth results; and
determining whether the first ML model and the second ML model are the same comprises:
in response to a significant statistical difference between the third results and the fourth results, determining that the first ML model and the second ML model are different.

14. The non-transitory computer-readable medium of claim 11, wherein:
conducting the statistical analysis comprises (i) comparing the third results and the fourth results using a statistical test, wherein the statistical test uses a significance level alpha, and (ii) generating a p-value from the statistical test; and
determining whether the user data was used for training the ML model comprises one of:
(i) in response to the p-value being lower than the significance level alpha, determining that the first ML model and the second ML model are different; or
(ii) in response to the p-value being higher than the significance level alpha, determining that the first ML model and the second ML model are the same.

15. A computer implemented method comprising:
generating statistical distribution of user data;
generating synthetic data by sampling from the statistical distribution of the user data;
feeding the user data and the synthetic data to an inference endpoint of a machine learning (ML) model;
receiving first results that are generated by the ML model, based on feeding the user data to the inference endpoint of the ML model;
receiving second results that are generated by the ML model, based on feeding the synthetic data to the inference endpoint of the ML model;
conducting statistical analysis, based at least in part on the first results and the second results;
determining whether the user data was used for training the ML model, based at least in part on conducting the statistical analysis; and
causing to display an indication of the determination as to whether the user data was used for training the ML model.

16. The method of claim 15, wherein conducting the statistical analysis comprises:
generating a user performance metric that is based at least in part on the first results;
generating a synthetic performance metric that is based at least in part on the second results; and
conducting the statistical analysis, based at least in part on the user performance metric and the synthetic performance metric.

17. The method of claim 16, wherein the user data comprises (i) a user input feature that was previously fed to the ML model and (ii) a user output feature that was previously generating by the ML model, based on feeding the user input feature to the ML model, and wherein generating the user performance metric comprises:
generating a user recommendation error, based at least in part on a difference between the user output feature and the first results; and
generating the user performance metric that is a function of the user recommendation error.

18. A system comprising:
one or more processors; and
one or more non-transitory computer-readable media storing instructions, which, when executed by the system, cause the system to perform a set of actions including:
generating statistical distribution of user data;
generating synthetic data by sampling from the statistical distribution of the user data;
feeding the user data and the synthetic data to an inference endpoint of a machine learning (ML) model;
receiving first results that are generated by the ML model, based on feeding the user data to the inference endpoint of the ML model;
receiving second results that are generated by the ML model, based on feeding the synthetic data to the inference endpoint of the ML model;
conducting statistical analysis, based at least in part on the first results and the second results;
determining whether the user data was used for training the ML model, based at least in part on conducting the statistical analysis; and
causing to display an indication of the determination as to whether the user data was used for training the ML model.

19. The system of claim 18, wherein conducting the statistical analysis comprises:
generating a user performance metric that is based at least in part on the first results;
generating a synthetic performance metric that is based at least in part on the second results; and
conducting the statistical analysis, based at least in part on the user performance metric and the synthetic performance metric.

20. The system of claim 19, wherein the user data comprises (i) a user input feature that was previously fed to the ML model and (ii) a user output feature that was previously generating by the ML model, based on feeding the user input feature to the ML model, and wherein generating the user performance metric comprises:
generating a user recommendation error, based at least in part on a difference between the user output feature and the first results; and
generating the user performance metric that is a function of the user recommendation error.

21. A non-transitory computer-readable medium including instructions that when executed by one or more processors, cause a system including the one or more processors to perform operations including:
feeding user data to an inference endpoint of a first machine learning (ML) model;
feeding the user data to a production system including a second ML model;
receiving first results from the first ML model, and second results from the production system;
conducting statistical analysis, based at least in part on the first results and the second results; and
determining whether the first ML model and the second ML model are the same, based at least in part on conducting the statistical analysis.

22. The non-transitory computer-readable medium of claim 21, wherein the operations further include:
causing to display an indication of the determination as to whether the first ML model and the second ML model are the same.

23. The non-transitory computer-readable medium of claim 21, wherein:
conducting the statistical analysis comprises comparing the first results and the second results.

24. The non-transitory computer-readable medium of claim 23, wherein determining whether the first ML model and the second ML model are the same comprises:
in response to a non-significant statistical difference between the first results and the second results, determining that the first ML model and the second ML model are the same.

25. The non-transitory computer-readable medium of claim 23, wherein determining whether the first ML model and the second ML model are the same comprises:
in response to a significant statistical difference between the first results and the second results, determining that the first ML model and the second ML model are different.

26. The non-transitory computer-readable medium of claim 23, wherein determining whether the first ML model and the second ML model are the same comprises one of:
(i) in response to a non-significant statistical difference between the first results and the second results, determining that the first ML model and the second ML model are the same, or
(ii) in response to a significant statistical difference between the first results and the second results, determining that the first ML model and the second ML model are different.

27. The non-transitory computer-readable medium of claim 21, wherein feeding the user data to the inference endpoint of the first ML model comprises feeding the user data to the inference endpoint by bypassing a frontend system of the first ML model.

28. The non-transitory computer-readable medium of claim 21, wherein feeding the user data to the production system comprises feeding the user data through a frontend system of the production system.

29. A method comprising:
feeding user data to an inference endpoint of a first machine learning (ML) model;
feeding the user data to a production system including a second ML model;
receiving first results from the first ML model, and second results from the production system;
conducting statistical analysis, based at least in part on the first results and the second results; and
determining whether the first ML model and the second ML model are the same, based at least in part on conducting the statistical analysis.

30. The method of claim 29, further comprising:
causing to display an indication of the determination as to whether the first ML model and the second ML model are the same.

31. The method of claim 29, wherein conducting the statistical analysis comprises comparing the first results and the second results.

32. The method of claim 31, wherein determining whether the first ML model and the second ML model are the same comprises:
in response to a non-significant statistical difference between the first results and the second results, determining that the first ML model and the second ML model are the same.

33. The method of claim 31, wherein determining whether the first ML model and the second ML model are the same comprises:
in response to a significant statistical difference between the first results and the second results, determining that the first ML model and the second ML model are different.

34. The method of claim 31, wherein determining whether the first ML model and the second ML model are the same comprises one of:
(i) in response to a non-significant statistical difference between the first results and the second results, determining that the first ML model and the second ML model are the same, or
(ii) in response to a significant statistical difference between the first results and the second results, determining that the first ML model and the second ML model are different.

35. The method of claim 29, wherein feeding the user data to the inference endpoint of the first ML model comprises feeding the user data to the inference endpoint by bypassing a frontend system of the first ML model.

36. The method of claim 29, wherein feeding the user data to the production system comprises feeding the user data through a frontend system of the production system.

37. A system comprising:
one or more processors; and
one or more non-transitory computer-readable media storing instructions, which, when executed by the system, cause the system to perform a set of actions including:
feeding user data to an inference endpoint of a first machine learning (ML) model;
feeding the user data to a production system including a second ML model;
receiving first results from the first ML model, and second results from the production system;
conducting statistical analysis, based at least in part on the first results and the second results; and
determining whether the first ML model and the second ML model are the same, based at least in part on conducting the statistical analysis.

38. The system of claim 37, wherein conducting the statistical analysis comprises comparing the first results and the second results.

39. The system of claim 37, wherein determining whether the first ML model and the second ML model are the same comprises:
in response to a non-significant statistical difference between the first results and the second results, determining that the first ML model and the second ML model are the same.

40. The system of claim 37, wherein determining whether the first ML model and the second ML model are the same comprises:
in response to a significant statistical difference between the first results and the second results, determining that the first ML model and the second ML model are different.
